(19) United States
(12) Patent Application Publication
(10) Pub. No.: US 2014/0369541 A1
(43) Pub. Date: Dec. 18, 2014

(54) Wearable Portable Speaker System For Mobile Electronic Devices

(71) Applicants: Michael Miskin, Sleepy Hollow, IL (US); Valerie Miskin, Sleepy Hollow, IL (US); Michael Miskin, Sleepy Hollow, IL (US); Matthew Miskin, Sleepy Hollow, IL (US)

(72) Inventors: Michael Miskin, Sleepy Hollow, IL (US); Valerie Miskin, Sleepy Hollow, IL (US); Michael Miskin, Sleepy Hollow, IL (US); Matthew Miskin, Sleepy Hollow, IL (US)

(21) Appl. No.: 14/281,707

(22) Filed: May 19, 2014

Related U.S. Application Data
(60) Provisional application No. 61/855,548, filed on May 17, 2013.

(51) Int. Cl. H04R 1/02

(52) U.S. Cl. CPC H04R 1/02
USPC 381/334

(57) ABSTRACT

A wearable portable speaker system for mobile electronic devices having at least one speaker capable of connecting to a mobile electronic device and a fixture for housing the at least one speaker. The fixture is formed as a collar having an opening formed therein and the at least one speaker is housed in the fixture so that an output of the speakers is at least partially directed upwards from a top portion of the fixture.

### RELATED APPLICATIONS

The application claims priority to U.S. Provisional Application No. 61/855,548 entitled “Wearable portable speaker system for mobile electronic devices method and apparatus” filed May 17, 2013—the contents which are expressly incorporated herein by reference.

### TECHNICAL FIELD

The present invention generally relates to a portable speaker system for mobile electronic devices. The present invention more specifically relates to a wearable speaker system for mobile electronic devices that can be secured to the neck of a person.

### FEDERALLY SPONSORED RESEARCH OR DEVELOPMENT

None.

### BACKGROUND OF THE INVENTION

Mobile electronic devices have rapidly evolved over the past several years. Portable handheld radios that were once capable of providing audio output of received broadcast radio signals have been replaced with PMP or MP3 audio players, many of which have radios integrated within them. A portable media player (PMP) or digital audio player (DAP) is a consumer electronics device that is capable of storing and displaying digital media such as audio, video, images, and documents. Data is typically stored on a hard drive, Microdrive, or a flash memory. In contrast, analog portable audio players play music from cassette tapes, records, or discs. Often digital audio players are sold as MP3 players, even if they support other file formats. Other types of electronic devices like cellphones or smart phones, tablet and laptop computers, and digital cameras may be referred as PMPs because of playback capabilities. Mobile and smart phones have advanced significantly since the release of the first cell phone technology and what was initially released as a portable phone that could be taken out of the home into the car solely for the purposes of making phone calls, has turned into a handheld computer having more processing power, capability, and features than early personal computers.

Depending on the particular applications or functions performed on a given mobile electronic device, oftentimes one or more accessories are used in combination with the portable electronic device. Examples of such accessories include hands-free headsets with integrated microphones for 2-way communication, or headphones, miniature head phones—commonly referred to as ear buds, and portable speakers are used for listening to audio from portable electronic devices. Existing headphones and ear buds are designed for a user to wear on their head either over the ears or in the ears and provide a method of listening to audio privately from portable electronic devices. Portable speakers, on the other hand, are designed to be placed on a surface and allow one or more users to listen to audio output from portable electronic devices in a less private way.

In comparison to portable speakers, headphones and ear buds provide a user with a better means of mobility while listening to audio with mobile electronic devices. It is common for a user to do indoor and/or outdoor activities while wearing headphones or ear buds such as walk, jog, bicycle, play sports or other activities such as fishing or hunting. Portable speakers are not designed to wear on the body and/or person and would be cumbersome and challenging to use when listening to audio from mobile electronic devices while doing some many activities.

While having the advantage of being mobile, headphones and ear buds can be problematic when used during some activities such as walking, jogging, bicycling or other mobile activities. The headphones and/or ear buds can move away and/or fall from the ears during the user's movement. Headphones and/or ear buds can also reduce safety in some cases when being used while walking, jogging, bicycling or other activities. The coverage and output audio from the headphones and/or ear buds can easily limit a user from being able to hear other sounds surrounding them. This can be dangerous while walking, jogging, bicycling or doing other activities near a road with passing cars.

It would be advantageous to have a wearable portable speaker system for mobile electronic devices that can be placed on the body near the ears but not on the head to cover the ears or inserted in the ears.

The present invention is provided to solve these and other issues.

### SUMMARY OF THE INVENTION

Accordingly the present invention is directed to a wearable portable speaker system for used with mobile electronic devices, which may be referred to throughout at the wearable portable speaker system. The wearable portable speaker system may be configured to be secured onto the neck of a user and provide at least one small audio speaker which may be positioned near the ear(s) of the user wearing the wearable portable speaker system. In this configuration, audio may be provided to a user wearing the wearable portable speaker system without having to covering their ears or inserting a device into their ears. This will allow the user to listen to music while also having the ability to hear ambient noise from their surroundings. Mobile electronic devices may include, for example, PMPs, MP3 players, DAPs, smart phones and cell phones, portable computers, like for example laptops or tablet computers, and portable radios which are digital or otherwise. Of course it is contemplated that the systems herein may be utilized with sound producing devices which are non-mobile electronic devices, like for example desktop computers, televisions, or the like. Essentially, the audio system described herein is capable of use with any device capable of producing sound.

According to one aspect of the invention, a wearable portable speaker system for mobile electronic devices is provided. The wearable portable speaker system includes at least one speaker capable of connecting to a mobile electronic device and a fixture for housing the at least one speaker. The fixture is formed as a collar having an opening formed therein, and may be shaped for example like a U-, C-, or horseshoe like shape. The at least one speaker is housed in the fixture so that an output of the speakers is at least partially directed upwards from a top portion of the collar, towards a user's ears when the collar is fitted around their neck.

The at least one speaker may be a wireless speaker capable of wirelessly connecting to a mobile electronics device. The at least one wireless speaker may include a receiver or transceiver capable of receiving audio signals from a mobile electronics device, may, for example, utilize Bluetooth protocols to wirelessly connect to a mobile electronic device.

The wearable portable speaker system may also include at least one repositionable arm integrated with the fixture. The at least one repositionable arm may have a first end and a second end, the first end being connected to or integrated with the fixture, and the second end is coupled to the at least one speaker. The at least one repositionable arm may be flexible and may also be formable so has to hold any position the arm is configured in by a user.

Rather than just have a single speaker, the wearable portable speaker system may include at least two speakers housed within the fixture, providing at least one speaker proximate each ear of a user. The at least two speakers housed within the fixture may be separated by a distance of at least two inches along the top of portion of the fixture, with the distance of at least two inches separating the at least two speakers being adjustable.

Regardless of whether one, two, or more speakers are utilized in the wearable portable speaker system, at least one rechargeable battery may be provided. The wearable portable speaker system may include an electrical connector for connecting the at least one rechargeable battery to a battery charger to recharge the battery.

The wearable portable speaker system may also include a mobile electronic device housing. At least a portion of the mobile electronic device housing may be clear and/or pliable. The mobile electronic device housing may also be weather resistant or proof, and may be integrated with the fixture, or removable coupled with or disconnectable from the fixture.

The fixture of the wearable portable speaker system may also be weather resistant or proof. In order to accommodate different users, a diameter of the fixture or collar may be adjustable to fit different sized necks and individuals. The fixture may also be flexible, and may be constructed from silicon rubber for example. The fixture may be capable of manipulation so that the direction of an audio output of the at least one speaker housed within the fixture may be adjusted.

Regardless of whether or not the at least one speaker is wireless, the wearable portable speaker system may also include at least one audio cable capable of connecting the at least one speaker to a mobile electronic device. The at least one audio cable may be removable or disconnectable from the wearable portable speaker system or integrated therewith. The at least one audio cable may be retractable. Regardless of whether or not the at least one audio cable is disconnectable or integrated, the fixture may be configured to at least partially house the at least one audio cable can be at least partially housed within the fixture.

Other aspects and features of the invention will become apparent to those having ordinarily skill in the art upon review of the following Description, Claims, and associated Drawings.

### BRIEF DESCRIPTION OF THE DRAWINGS

FIG. 1 shows a top view of a wearable portable speaker system;

FIG. 2 shows a bottom view of the wearable portable speaker system shown in FIG. 1;

FIG. 3 shows a side view of the wearable portable speaker system shown in FIG. 1;

FIG. 4 shows a cross-section taken along the line 4-4 in FIG. 1; and

FIG. 5 shows a front perspective view of the wearable portable speaker system shown in FIG. 1 having the repositionable arms extended.

### DETAILED DESCRIPTION OF PREFERRED EMBODIMENTS

While this invention is susceptible to embodiments in many different forms, there is described in detail herein, various embodiments of the invention with the understanding that the present disclosures are to be considered as exemplifications of the principles of the invention and are not intended to limit the broad aspects of the invention to the embodiments illustrated.

FIG. 1 shows a top view of a wearable portable speaker system 10 for use with mobile electronic devices. Wearable portable speaker system 10 includes at least one speaker 12 and fixture 14 for housing the at least one speaker. As seen in FIG. 1, fixture 14 may be formed in a C- or U- or horseshoe shaped element, formed as a collar for fitting around the neck of a user or individual. Fixture 14 is configured to at least partially house speaker 12, and to do so may include channel or cutout 16 which will allow speaker 12 to sit down within fixture 14.

In order to better protect speaker 12 and any other internal electrical components, fixture 14 may be weather resistant or proof, and in particular water resistant or proof. Fixture 14 may include covers 18 which are removable and replaceable on the top portion or face 20 of fixture 14. These covers may also be substantially weather resistant or proof and/or may include any necessary apertures or the like to allow audio output to escape through the covers. The covers may be coupled fixture 14 at point 22 at which the cover may be rotated to allow access to the speaker. Point 22 may be, for example, a pin or similar connector which will allow the rotation while also allowing for removable so that covers 18 may be removed or replaced.

Though discussed as at least one speaker thus far, wearable portable speaker system 10 may preferably include two speakers 12, 24 in order to place one speaker proximate each of a user's ears when wearable portable speaker system 10 is worn on a user's neck. Though at times the invention will be discussed in reference to at least one speaker or a single speaker, and at other times having at least two speakers or both speakers, it should be understood that except where specifically mentioned, the characteristics of any speaker or system discussed herein are usable interchangeably between speakers and systems having at least one speaker or at least two speakers. Any characteristics discussed with respect to a single speaker wearable portable speaker system may be used in a wearable portable speaker system with two or more speakers. Likewise, any characteristics discussed herein for a wearable portable speaker system having two or more speakers may be used with a wearable portable speaker system having one speaker.

Whether one or two speakers are used, at least one speaker, like for example speaker 12, may be wireless so as to be capable of wireless coupling to a mobile electronic device in order to playback audio. Any wireless speaker may include any required receivers, transceivers, batteries, or electronics required to receive and drive the speaker and provide audio playback. Any wireless speakers may operate using, for example Bluetooth protocols, or may otherwise operate using other known wireless communication technology. In wearable portable speaker systems where only one speaker is wireless, and multiple speakers are in the system, the speakers may be wired or electrically connected together to allow for wirelessly received audio signals may be provided to each speaker. Any wires utilized to connect speakers may be housed within fixture 14.

Where at least one wireless speaker is used a single rechargeable battery 26 may be provided and housed within fixture 14 and electrically connected to each wireless speaker using an electrical conductor, like a wire, housed within fixture 14. Whether each speaker in the wearable portable speaker system includes a battery, a single rechargeable battery, or both is provided in the wearable portable speaker system, a battery charger connection port 28 may be provided to allow for the recharging of any rechargeable batteries. Port 28 may be any known recharging port known in the art, like for example a USB port or a port capable of receiving a plug or connector end of a power cable. Port 28 may be electrically connected to any batteries utilizing common wires or other conductors housed within fixture 14. Any additional electronics required to step up, step down, rectify or otherwise change any input power signal may be also be provided within fixture 14.

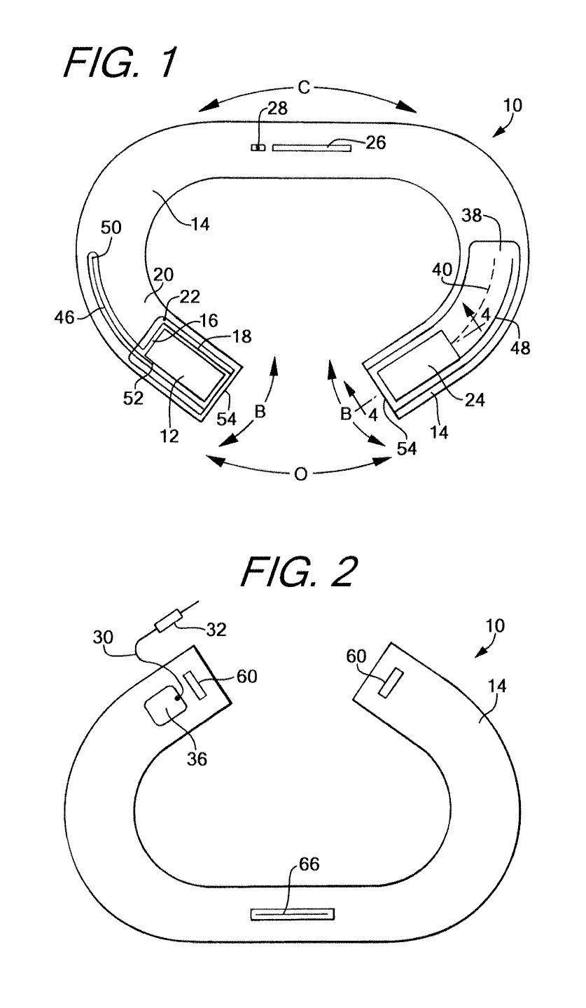

Rather than connect wirelessly, or in some cases in addition to connecting wirelessly as a failsafe should wireless connections be unavailable or unwanted, wearable portable speaker system 10 may include an audio cable 30 as seen in FIG. 2 which is a bottom view of the wearable portable speaker system shown in FIG. 1. Audio cable 30 may be a standard audio cable having any necessary or known connection element in the art for connecting to a mobile electronic device, like for example, an audio jack 32 or a USB connector. Audio cable 30 may be directly integrated with the wearable portable speaker system and coupled to each speaker within the system either directly or indirectly. Alternatively, audio cable 30 may be disconnectable from wearable portable speaker system 10 so as to be used with other devices. When integrated directly with fixture 14, the at least one audio cable may be retractable so as to be capable of being wound and unwound as needed. Any retractable cord may be locking so as to provide slack for improved movement when necessary.

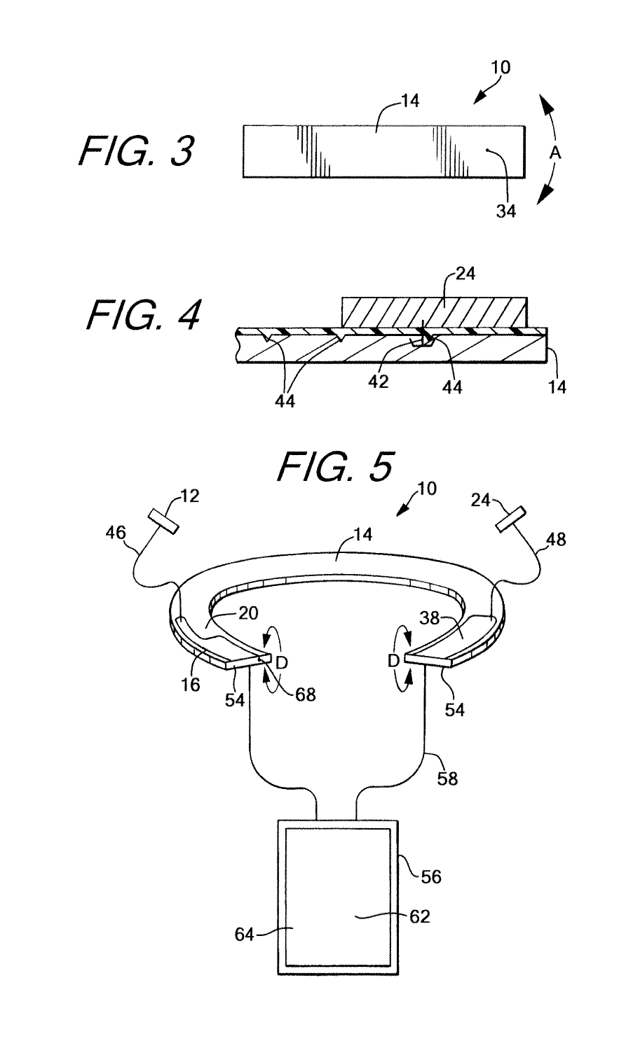

As shown in FIG. 3, which is a side view of the wearable portable speaker system shown in FIG. 1, when a disconnectable audio cable 30 is utilized, a connection port like port 34 may be provided in fixture 14 so that audio cable 30 may be connected. A disconnectable audio cable and port 34 may be any combination of known connection elements, like for example an audio cable jack and port or USB connector and port.

In order to store audio cable 30, whether integrated with wearable portable speaker system 10 and retractable or not retractable, or removably engaged with wearable portable speaker system, fixture 14 may include housing 36 which can been seen in FIG. 2. Housing 36 may be selectively opened and closed to allow access to the audio cable as needed, and allow for the audio cable to be at least partially stored within the housing when wearable portable speaker system 10 is or is not in use.

As seen in FIG. 1, both speakers 12, 24 may be housed within fixture 14, each having their own channels 16, 38 respectively. In order to insure that at least one of the at least two speakers is proximate each user ear, the speakers should be housed within fixture 14 at least two inches apart from each other. The distance between, and position of, the speakers may be adjustable particularly where a longer channel like channel 38 is provided. Where a wearable portable speaker system includes two speakers, channels 16, 26 may be used together in a single wearable portable speaker system as shown in FIG. 1. Alternatively, both channels in a wearable portable speaker system may be configured like channel 16 where the speaker is housed within fixture 14 in a relatively fixed position, or both speakers may be housed in a channel like channel 38 to allow for the repositioning and movement of both speakers.

In order to move a speaker within fixture 14 and thereby change the location of the speaker and potentially change the distance between multiple speakers in the wearable portable speaker system, track 40 may be provided in one or both speaker channels. In order to utilize track 40, any speaker coupled to the track may include an engaging or insert member which will insert into the track to better guide and engage a speaker within the channel. Notches may be provided along the track or within the channel to further engage the speaker or any engaging or insert member to prevent each speaker from sliding once positioned within the channel. An example of such a configuration can be seen in FIG. 4 which is a cross-section taken along line 4-4 in FIG. 1. As seen in FIG. 4, engaging or insert member 42 may extend through the track and engage engaging element 44 in order to prevent speaker 24 from sliding within channel 38. One or both of engaging member 42 or engaging element 44 may be flexible and resilient so as to allow for easier movement of any connected speaker. Speakers 12, 24 may also have a directional, or a directionally adjustable, audio output which will project and focus the audio output of the speakers in a particular direction, for example, upwards from fixture 14 and towards a user's ears when wearable portable speaker system 10 is worn on a user's neck.

In order to further adjust or manipulate the output of any speaker included within the wearable portable speaker system, at least one repositionable arm 46 may be provided in wearable portable speaker system 10. Repositionable arm 46 may be housed within fixture 14 in a narrower extension of channel 16, or may be housed within the same channel as the coupled speaker as shown with repositionable arm 48. Though shown in FIG. 1 as having a repositionable arm attached to each of speakers 12, 24, only a single repositionable arm may be used in a particular design to allow for at least one speaker to be moved relative to the fixture, while the other speakers remain fixed.

Each repositionable arm may also be slidably engaged with a speaker so that a speaker may be moved along fixture 14 as described above with respect to track 40. Any coupled speakers may be capable of sliding along repositionable and being locked into place along the arm, so that the repositionable arm may allow for the movement of the speaker at that location, as well as all a user to slide the speaker within the channel housing the speaker.

In embodiments where wires extend between speakers and/or speaker(s) and a battery or other element, any repositionable arms may be substantially allow to allow the wire to extend therein to the speaker coupled to the repositionable arm.

Where repositionable arms are used, each repositionable arm will have a first end 50 which is coupled or attached to fixture 14, and a second end 52 which is coupled to the at least one speaker, shown as speaker 12. As seen in FIG. 5, which is a front perspective view of the wearable portable speaker system shown in FIG. 1, when extended, any repositionable arms may be flexible so as to allow for a greater range of positions to which a connected speaker may be moved. Any repositionable arms may also be formable, as seen with repositionable arm 48 in FIG. 5, so that the repositionable arm may hold any coupled speaker in place once a user has flexed the arm and manipulated it to move the speaker to where the user desires.

In order to provide further positioning options for a user, and to allow for the shape and size of wearable portable speaker system 10 to be manipulated and changed to accommodate different users or uses, fixture 14 may be flexible and formable as well. FIGS. 1, 3, and 5 show that fixture 14 may be flexible in any number of ways, including moving ends 54 of fixture 14 up and down (as seen in direction A in FIG. 3), moving ends 42 sideways (direction B in FIG. 1), or to make fixture 14 wider or narrower by flexing the body (direction C in FIG. 1). Moving ends 54 in the manner shown in FIG. 1 will allow for opening O to be made larger or smaller, and allow for fixture 14 to be reconfigured, accommodating a larger or smaller neck in wearable portable speaker system 10.

In addition to moving up and down and sideways, ends 42 of fixture 14 may also be rotatable (direction D in FIG. 5) so as to direct the output of speakers into or away from a user's ear or ears. Ends 42 may be movable independent of each other, and as a result of the formability of fixture 14, will substantially remain in the position to which the user has manipulated the fixture.

In order to prevent skin burning on a user's neck and the heating up of fixture 14, it is contemplated that at least the surface of fixture 14 may be made of silicon rubber. Silicon rubber is substantially weather proof or resistant, is flexible, and will not heat up due to sunlight or body heat. This will prevent fixture 14 from getting too hot and potentially burning a user, and will help to further protect any electrical elements housed within fixture 14.

In addition to providing fixture 14 to house any speakers and required electronics, wearable portable speaker system 10 may include mobile electronic device housing 56 for housing any mobile electronic devices used with the wearable portable speaker system, as seen in FIG. 5. Mobile electronic device housing 56 may be integrated with, or disconnectable from, fixture 14 so that a user can selectively house any mobile electronic device, or remove the mobile electronic device housing entirely when desired. The mobile electronic device housing may be formed as part of fixture 14, or more preferably, include lanyard 58 which may be removably coupled or integrated with fixture 14 so that both the lanyard and mobile electronic device housing can be removed when desired. Lanyard 58 may be connected fixture 14 utilizing hooks, clips, or other attachment elements formed in or on fixture 14, positioned at element 60 in FIG. 2 for example. Alternatively, lanyard 58 and mobile electronic device housing 56 may be separate elements, with lanyard 58 being stored in a compartment within fixture 14 until needed. Mobile electronic device housing 56 may then be engageable with lanyard 58 using a clip, hook, or some other fastener device formed in or on mobile electronic device housing 56.

In order to allow for viewing and use of a mobile electronic device within any mobile electronic device housing 56, at least a portion of mobile electronics device housing 56 may be clear 62 and/or pliable 64. Making the screen at least partially clear and at least partially pliable will allow a user to view and use or manipulate a housed mobile electronic device without having to remove the device from the housing. Mobile electronic device housing 56 may also be weather resistant or weather proof in order to protect the device from rain or the like. Any required openings required for audio or power jacks may be provided within housing 56 as well.

In wearable portable speaker systems where a rechargeable battery is included, as seen in FIG. 2, it is contemplated that port 66 may be provided in order to allow a mobile electronic device to connect and charge or operate using the rechargeable battery. In emergencies where the mobile electronic device is a smart phone, for example, and the smart phone battery power is low, charging from the rechargeable battery in the wearable portable speaker system may be desirable or required. Port 66 may be any known port capable of receiving a power cord to provide power to a mobile electronic device, including but not limited to a USB port.

Insofar at least one speaker within wearable portable speaker system may be wireless and include a transceiver, wearable portable speaker system 10 may include a microphone 68 as shown in FIG. 5. As shown in FIG. 5, the microphone may be located in one end 54 of fixture 14. Microphone 68 may also, or alternatively, be attached to a repositionable arm similar repositionable arms 46, 48, to allow a user to move the microphone closer to or further away from the user's mouth. Where a microphone is included along with at least one wireless speaker having a transceiver, wearable portable speaker system 10 may be utilized as both a hands free headset and a wearable portable speaker system.

While the foregoing there has set forth embodiments of the invention, it is to be understood that the present invention may be embodied in other forms without departing from the spirit or central characteristics thereof. The present embodiments, therefore, are to be considered in all respects as illustrative and not restrictive, and the invention is not to be limited to the details given herein. While specific embodiments have been illustrated and described, numerous modifications come to mind without significantly departing from the characteristics of the invention and the scope of protection is only limited by the scope of the accompanying claims.

What is claimed is:

1. A wearable portable speaker system for mobile electronic devices comprising:
at least one speaker capable of connecting to a mobile electronic device;
a fixture for housing the at least one speaker, the fixture being formed as a collar having an opening formed therein,
wherein the at least one speaker is housed in the fixture so that an output of the speakers is at least partially directed upwards from a top portion of the fixture.

2. The wearable portable speaker system for mobile electronic devices of claim 1 wherein the at least one speaker is a wireless speaker.

3. The wearable portable speaker system for mobile electronic devices of claim 2 wherein the at least one wireless speaker utilizes Bluetooth protocols to wirelessly connect to a mobile electronic device.

4. The wearable portable speaker system for mobile electronic devices of claim 1 wherein the fixture is weather resistant.

5. The wearable portable speaker system for mobile electronic devices of claim 1 further comprising at least one repositionable arm integrated with the fixture, the at least one repositionable arm having a first end and a second end, wherein the first end is connected to the fixture and the second end is coupled to the at least one speaker.

6. The wearable portable speaker system for mobile electronic devices of claim 5 wherein the at least one repositionable arm is flexible.

7. The wearable portable speaker system for mobile electronic devices of claim 6 wherein the at least one repositionable arm is formable.

8. The wearable portable speaker system for mobile electronic devices of claim 1 further comprising at least two speakers, wherein the at least two speakers are housed within the fixture.

9. The wearable portable speaker system for mobile electronic devices of claim 8 wherein the at least two speakers housed within the fixture are separated by a distance of at least two inches.

10. The wearable portable speaker system for mobile electronic devices of claim 9 wherein the distance of at least two inches the at least two speakers are separated, is adjustable.

11. The wearable portable speaker system for mobile electronic devices of claim 1 comprising at least one rechargeable battery.

12. The wearable portable speaker system for mobile electronic devices of claim 11 further comprising an electrical connector for connecting the at least one rechargeable battery to a battery charger.

13. The wearable portable speaker system for mobile electronic devices of claim 1 further comprising a mobile electronic device housing.

14. The wearable portable speaker system for mobile electronic devices of claim 13 wherein at last a portion of the mobile electronic device housing is clear.

15. The wearable portable speaker system for mobile electronic devices of claim 13 wherein at least a portion of the mobile electronic device housing is pliable.

16. The wearable portable speaker system for mobile electronic devices of claim 13 wherein the mobile electronic device housing is weather resistant.

17. The wearable portable speaker system for mobile electronic devices of claim 13 wherein the mobile electronic device housing is integrated with the fixture.

18. The wearable portable speaker system for mobile electronic devices of claim 1 wherein the fixture is flexible.

19. The wearable portable speaker system for mobile electronic devices of claim 18 wherein the fixture is constructed from silicon rubber.

20. The wearable portable speaker system for mobile electronic devices of claim 1 further comprising at least one audio cable, the at least one audio cable being capable of connecting the at least one speaker to a mobile electronic device.

21. The wearable portable speaker system for mobile electronic devices of claim 20 wherein the at least one audio cable is removable.

22. The wearable portable speaker system for mobile electronic devices of claim 20 wherein the at least one audio cable is retractable.

23. The wearable portable speaker system for mobile electronic devices of claim 20 wherein the at least one audio cable can be at least partially housed within the fixture.
